(19) United States
(12) Patent Application Publication
(10) Pub. No.: US 2018/0311698 A1
(43) Pub. Date: Nov. 1, 2018

(54) METHOD AND DEVICE FOR APPLYING ALIGNMENT LIQUID

(71) Applicants: BOE TECHNOLOGY GROUP CO., LTD., Beijing (CN); BEIJING BOE DISPLAY TECHNOLOGY CO., LTD., Beijing (CN)

(72) Inventors: Tengteng HU, Beijing (CN); Jinyu REN, Beijing (CN); Bo ZHOU, Beijing (CN); Junjie LI, Beijing (CN); Songfei CHEN, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 15/503,206

(22) PCT Filed: Aug. 10, 2016
(86) PCT No.: PCT/CN2016/094404

§ 371 Date: Feb. 10, 2017

(30) Foreign Application Priority Data
Jan. 4, 2016 (CN) 201610006420.X

(51) Int. Cl. B05C 11/10; G02F 1/1337

(52) U.S. Cl. CPC B05C 11/1039; B05D 3/12; G02F 1/1337

(57) ABSTRACT

The present disclosure provides a method and a device for applying an alignment liquid. The method includes steps of providing a substrate which includes a display region and a non-display region surrounding the display region, applying the alignment liquid onto the substrate at an alignment liquid application region covering an entirety of the display region and at least a part of the non-display region surrounding the display region, and removing the at least the part of the alignment liquid at the non-display region through vacuum adsorption.

### CROSS-REFERENCE TO RELATED APPLICATION

The present application claims a priority of the Chinese patent application No. 201610006420.X filed on Jan. 4, 2016, which is incorporated herein by reference in its entirety.

### TECHNICAL FIELD

The present disclosure relates to the field of liquid crystal display technology, in particular to a method and a device for applying an alignment liquid.

### BACKGROUND

In the related art, a method for applying an alignment liquid mainly includes a roller technique and an ink-jetting technology. However, it is impossible for these technologies to ensure an even thickness of the alignment liquid at a peripheral region and a center region. Usually, at the peripheral region, the alignment liquid has a thickness of greater than 5000 Å, while at the center region, it has a thickness of 400 Å.

For a display device in the related art, external connection points for signal lines (e.g., data lines and gate lines) may be arranged at a non-display region of an array substrate, and these external connection points may be used for the connection to an external signal device, such as an integrated circuit (IC) chip for controlling the display, and a detection probe for detecting a yield rate of the array substrate. Hence, these external connection points cannot be covered by the alignment liquid, and thus currently the alignment liquid may merely be applied onto a display region. However, at a periphery of the display region, i.e., at a periphery of a region where the alignment liquid is applied, the thickness of the alignment liquid is relatively large, and thus the display quality may be adversely affected.

### SUMMARY

An object of the present disclosure is to provide a scheme for applying the alignment liquid, so as to improve the thickness evenness of the alignment liquid at the display region, thereby to prevent the display quality from being adversely affected.

In one aspect, the present disclosure provides in some embodiments a method for applying an alignment liquid, including steps of: providing a substrate which includes a display region and a non-display region surrounding the display region; applying the alignment liquid onto the substrate at an alignment liquid application region covering an entirety of the display region and at least a part of the non-display region surrounding the display region; and removing at least a part of the alignment liquid at the non-display region through vacuum adsorption.

In a possible embodiment of the present disclosure, signal lines are arranged at the display region, external connection points for the signal lines are arranged at the non-display region, and the alignment liquid application region includes a region where the external connection points are located. The step of removing at least a part of the alignment liquid at the non-display region through vacuum adsorption includes: merely removing the alignment liquid at the region where the external connection points are located through a vacuum adsorption mechanism.

In a possible embodiment of the present disclosure, the vacuum adsorption mechanism includes a suction nozzle, and the step of merely removing the alignment liquid at the region where the external connection points are located through the vacuum adsorption mechanism includes: controlling the suction nozzle of the vacuum adsorption mechanism in such a manner as to remove, through vacuum adsorption, the alignment liquid at the region where each external connection point is located in accordance with an arrangement direction of the external connection points.

In a possible embodiment of the present disclosure, an adsorption width of the suction nozzle is equal to a sum of a width of each external connection point and a diffusion coefficient of the alignment liquid.

In a possible embodiment of the present disclosure, the diffusion coefficient of the alignment liquid is 0.8 mm to 3.2 mm.

In another aspect, the present disclosure provides in some embodiments a device for applying an alignment liquid, including: a delivery mechanism configured to deliver a substrate to a region where the alignment liquid is to be applied, the substrate including a display region and a non-display region surrounding the display region; an application mechanism configured to apply the alignment liquid to the substrate at an alignment liquid application region covering an entirety of the display region and at least a part of the non-display region surrounding the display region; a vacuum adsorption mechanism configured to absorb the alignment liquid on the substrate through vacuum adsorption; and a control mechanism configured to control the vacuum adsorption mechanism in a such manner as to remove, through vacuum adsorption, at least a part of the alignment liquid at the non-display region.

In a possible embodiment of the present disclosure, signal lines are arranged at the display region, external connection points for the signal lines are arranged at the non-display region, and the alignment liquid application region includes a region where the external connection points are located. The control mechanism is further configured to control the vacuum adsorption mechanism in such a manner as to merely remove the alignment liquid at the region where the external connection points are located.

In a possible embodiment of the present disclosure, the vacuum adsorption mechanism includes a suction nozzle, and the control mechanism is further configured to control the suction nozzle of the vacuum adsorption mechanism in such a manner as to remove, through vacuum adsorption, the alignment liquid at the region where each external connection point is located in accordance with an arrangement direction of the external connection points.

In a possible embodiment of the present disclosure, an adsorption width of the suction nozzle is equal to a sum of a width of each external connection point and a diffusion coefficient of the alignment liquid.

In a possible embodiment of the present disclosure, the diffusion coefficient of the alignment liquid is 0.8 mm to 3.2 mm.

In a possible embodiment of the present disclosure, the suction nozzle is of a rectangular opening, and an adsorption force Y of the suction nozzle is calculated using a formula: Y=A/(l+d+w)≥≥ρg*[w′*l*t], where A represents an inherent adsorption force of the suction nozzle, d represents a coefficient determined by a distance between the suction nozzle and the alignment liquid, w represents a coefficient determined by a width of the opening of the suction nozzle, ρ represents a density of the alignment liquid, g represents a gravity constant, w′ represents the adsorption width of the suction nozzle, l represents a length of the opening of the suction nozzle, and t represents a thickness of the alignment liquid.

According to the embodiments of the present disclosure, as compared with the related art, the region where the alignment liquid is to be applied increases, so the peripheral region of the applied alignment liquid is located at the non-display region. The alignment liquid at the positions in the non-display region where the alignment liquid shall not be applied may be removed through vacuum adsorption. As a result, it is able to ensure the thickness evenness of the alignment liquid at the display region.

### BRIEF DESCRIPTION OF THE DRAWINGS

In order to illustrate the technical solutions of the present disclosure in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort. Shapes and sizes of the members in the drawings are for illustrative purposes only, but shall not be used to reflect any actual scale.

FIG. 1 is a flow chart of a method for applying an alignment liquid according to one embodiment of the present disclosure;

FIGS. 2-4 are schematic views showing the method for applying alignment liquid according to one embodiment of the present disclosure;

FIG. 5 is a schematic view showing the position relationship between a suction nozzle of a device for applying the alignment liquid and external connection points during vacuum adsorption according to one embodiment of the present disclosure; and

FIG. 6 is a schematic view showing the device for applying the alignment liquid according to one embodiment of the present disclosure.

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

The present disclosure aims to provide a scheme for solving the problem in the related art where an alignment liquid has an uneven thickness at a periphery of a display region.

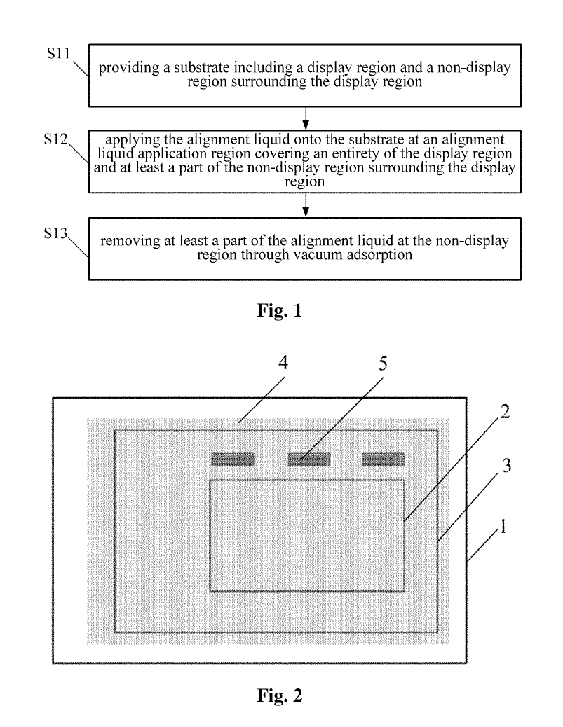

As shown in FIG. 1, the present disclosure provides in some embodiments a method for applying an alignment liquid, including: Step S11 of providing a substrate which includes a display region and a non-display region surrounding the display region; Step S12 of applying the alignment liquid onto the substrate at an alignment liquid application region covering an entirety of the display region and at least a part of the non-display region surrounding the display region; and Step S13 of removing at least a part of the alignment liquid at the non-display region through vacuum adsorption. The expression “at least a part of the alignment liquid” refers to that all the alignment liquid at the non-display region may be removed through vacuum adsorption, or the alignment liquid at a portion of the non-display region proximate to the display region may be reserved, so as to prevent the alignment liquid applied at the display region from being adversely affected during the adsorption.

In the embodiments of the present disclosure, the alignment liquid application region may fully cover the entire substrate, or merely cover the display region and a part of the non-display region.

According to the embodiments of the present disclosure, as compared with the related art, the region where the alignment liquid is to be applied increases, so the peripheral region of the applied alignment liquid is located at the non-display region. The alignment liquid at the positions in the non-display region where the alignment liquid shall not be applied may be removed through vacuum adsorption. As a result, it is able to ensure the thickness evenness of the alignment liquid at the display region.

To be specific, for an array substrate of a display device in the related art, signal lines are arranged at the display region, and external connection points for the signal lines are arranged at the non-display region. The external connection points need to be connected to an external signal device, and cannot be covered by the alignment liquid. In order to improve the adsorption efficiency, in the embodiments of the present disclosure, the vacuum adsorption may be performed on merely the alignment liquid at the non-display region that needs to be removed. In other words, in the above Step S13, merely the alignment liquid at the region where the external connection points are located may be removed through the vacuum adsorption mechanism.

The method for applying the alignment liquid in the embodiments of the present disclosure will be description hereinafter in more details.

As shown in FIG. 1, at first, the alignment liquid 4 may be applied to the display region 2 and at least a part of the non-display region 3 of the substrate 1. The alignment liquid application region includes a portion of the non-display region 3 where the external connection points 5 for a part of the signal lines are located.

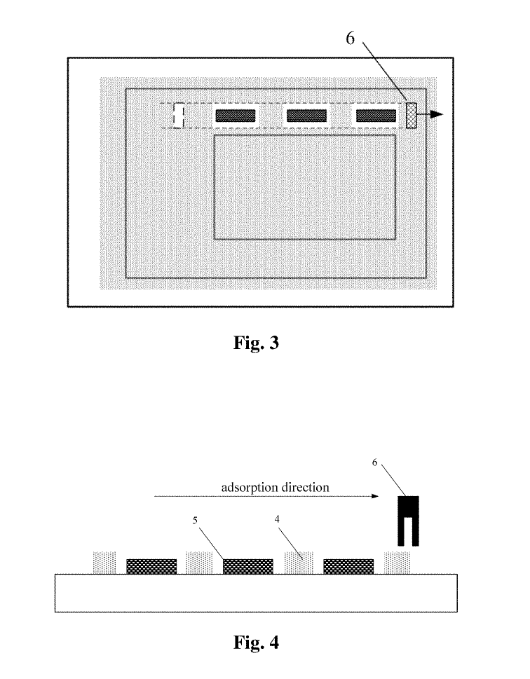

Then, as shown in FIGS. 3 and 4, a suction nozzle 6 of the vacuum adsorption mechanism may be controlled in such a manner as to remove, through vacuum adsorption, the alignment liquid at the region where each external connection point 5 is located in accordance with an arrangement direction of the external connection points 5, so as to enable the alignment liquid 4 to form a hollowed-out portion at the region where the external connection points 5 are located.

In the embodiments of the present disclosure, it is able to perform accurate vacuum adsorption on the alignment liquid at a portion of the non-display region where the external connection points are located, so as to improve the adsorption efficiency, thereby to reduce a time cost for manufacturing the array substrate.

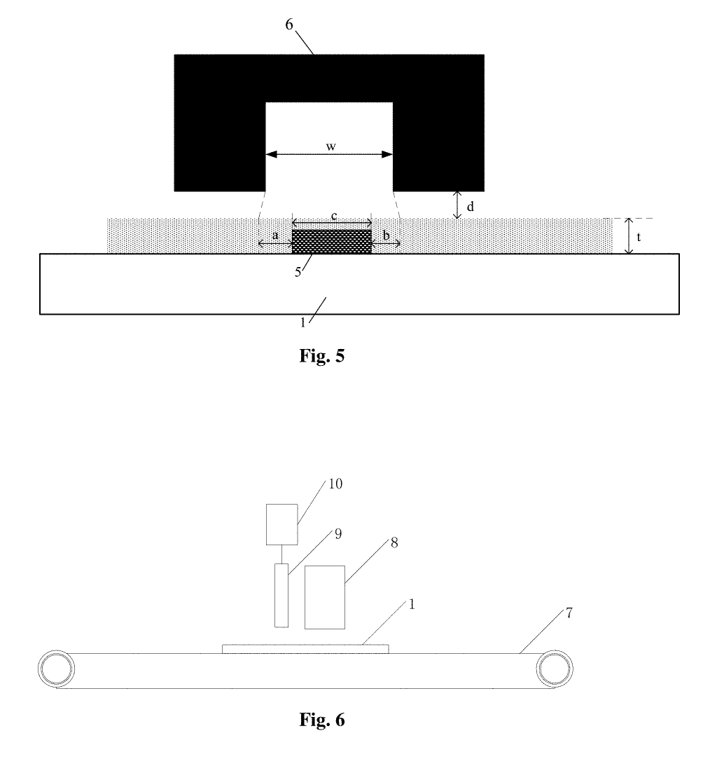

To be specific, as shown in FIG. 5, an adsorption width of the suction nozzle 6 is slightly greater than a width c of each external connection point by a distance a+b which is just a diffusion coefficient of the alignment liquid. This diffusion coefficient refers to, after the hollowed-out portion of the alignment liquid is formed through the suction nozzle, a distance that the alignment liquid moves toward the hollowed-out portion, due to an internal stress of the alignment liquid (usually it has a value in a range from 0.8 mm to 3.2 mm), i.e., a movement allowance of the alignment liquid toward the application region due to the adsorption width of the suction nozzle 6 after the vacuum adsorption.

As compared with the related art, the above method in the embodiments of the present disclosure has the following advantages. (1) The alignment liquid application region increases, and if necessary, it is able to apply the alignment liquid onto the entire substrate. In this way, it is able to, on one hand, prevent a pixel from being adversely affected by an uneven alignment film, and on the other hand, prevent the quality of the alignment film obtained by curing the alignment liquid from being degraded due to uneven steps at the peripheral region, and prevent the peripheral region from being adversely affected. (2) The vacuum adsorption may easily be performed so as to accurately control an adsorption position.

As shown in FIG. 6, the present disclosure further provides in some embodiments a device for applying the alignment liquid, including: a delivery mechanism 7 configured to deliver a substrate to a region where the alignment liquid is to be applied, the substrate including a display region and a non-display region surrounding the display region; an application mechanism 8 configured to apply the alignment liquid to the substrate at an alignment liquid application region covering an entirety of the display region and at least a part of the non-display region surrounding the display region; a vacuum adsorption mechanism 9 configured to absorb the alignment liquid on the substrate through vacuum absorption; and a control mechanism 10 configured to control the vacuum adsorption mechanism 9 in a such manner as to remove, through vacuum adsorption, at least a part of the alignment liquid at the non-display region.

According to the embodiments of the present disclosure, as compared with the related art, the region where the alignment liquid is to be applied increases, so the peripheral region of the applied alignment liquid is located at the non-display region. The alignment liquid at the positions in the non-display region where the alignment liquid shall not be applied may be removed through a vacuum adsorption mechanism. As a result, it is able to ensure the thickness evenness of the alignment liquid at the display region.

To be specific, in order to improve the adsorption efficiency, in the embodiments of the present disclosure, the vacuum adsorption may be performed on merely the alignment liquid at the non-display region that needs to be removed. In an array substrate of a display device in the related art, signal lines are arranged at the display region, and external connection points for the signal lines are arranged at the non-display region. The external connection points need to be connected to an external signal device, and cannot be covered by the alignment liquid. Thus, in the above Step S13, merely the alignment liquid at the region where the external connection points are located may be removed through the vacuum adsorption mechanism.

In a possible embodiment of the present disclosure, the vacuum adsorption mechanism 9 includes a suction nozzle, and the control mechanism 10 is further configured to control the suction nozzle of the vacuum adsorption mechanism in such a manner as to remove, through vacuum adsorption, the alignment liquid at the region where each external connection point is located in accordance with an arrangement direction of the external connection points.

In a possible embodiment of the present disclosure, the suction nozzle is of a rectangular opening. During the adsorption, the suction nozzle may move in a path as shown in FIG. 3, so as to facilitate the alignment with a pattern of each external connection point.

An adsorption force of the suction nozzle may be calculated using an equation Y=A/(l+d+w), where, as shown in FIG. 5, A represents an inherent adsorption force of the suction nozzle, d represents a coefficient determined by a distance between the suction nozzle and the alignment liquid (the larger the distance between the suction nozzle and the alignment liquid is, the larger a value of d is, and vice versa), w represents a coefficient determined by a width of the opening of the suction nozzle (the larger the width of the opening of the suction nozzle is, the larger a value of W is, and vice versa), ρ represents a density of the alignment liquid, g represents a gravity constant, w′ represents the adsorption width of the suction nozzle (w′=a+b+c, where a+b represents the diffusion coefficient of the alignment liquid, i.e., a movement allowance of the alignment liquid toward the hollowed-out portion after the adsorption, and usually a≈b≥0.8 mm (the smaller the better)), c represents a width of a pattern of the external connection point 5, l represents a length (not shown in FIG. 5) of the opening of the suction nozzle, and t represents a thickness of the applied alignment liquid.

In the case that Y≥ρg*[w′*l*t], the alignment liquid may be removed through the vacuum adsorption.

Through the establishment of the above-mentioned mathematical model, the length l and the width w of the opening of the suction nozzle may be set appropriately, and then the distance d between the suction nozzle and the alignment liquid may be adjusted, so as to accurately remove the alignment liquid at a region adjacent to the external connection points 5 through vacuum adsorption and expose the external connection points through the hollowed-out region, thereby to prevent the subsequent bonding procedure for the external signal device from being adversely affected. In addition, even in the case that a halo region is formed around the external connection point due to the vacuum adsorption, this halo region may be located at a position far away from the display region. As a result, in contrast to the process in the related art, the alignment liquid at the display region as well as the application quality of the alignment liquid may not be adversely affected in the embodiments of the present disclosure.

Obviously, the device for applying the alignment liquid corresponding the above-mentioned method for applying the alignment liquid, so an identical technical effect may be achieved.

The above are merely the preferred embodiments of the present disclosure. Obviously, a person skilled in the art may make further modifications and improvements without departing from the spirit of the present disclosure, and these modifications and improvements shall also fall within the scope of the present disclosure.

What is claimed is:

1. A method for applying an alignment liquid, comprising:
providing a substrate which comprises a display region and a non-display region surrounding the display region;
applying the alignment liquid onto the substrate at an alignment liquid application region covering an entirety of the display region and at least a part of the non-display region surrounding the display region; and
removing at least a part of the alignment liquid at the non-display region through vacuum adsorption.

2. The method according to claim 1, wherein
signal lines are arranged at the display region, external connection points for the signal lines are arranged at the non-display region, and the alignment liquid application region comprises a region where the external connection points are located; and
removing at least a part of the alignment liquid at the non-display region through the vacuum adsorption comprises: merely removing the alignment liquid at the region where the external connection points are located through a vacuum adsorption mechanism.

3. The method according to claim 2, wherein
the vacuum adsorption mechanism comprises a suction nozzle; and
merely removing the alignment liquid at the region where the external connection points are located through the vacuum adsorption mechanism comprises: controlling the suction nozzle of the vacuum adsorption mechanism, to remove, through vacuum adsorption, the alignment liquid at the region where each of the external connection points is located in accordance with a direction in which the external connection points are arranged.

4. The method according to claim 3, wherein an adsorption width of the suction nozzle is equal to a sum of a width of each of the external connection points and a diffusion coefficient of the alignment liquid.

5. The method according to claim 4, wherein the diffusion coefficient of the alignment liquid is in a range from 0.8 mm to 3.2 mm.

6. The method according to claim 3, wherein
the suction nozzle is of a rectangular opening; and
an adsorption force Y of the suction nozzle is calculated using a formula: Y=A/(l+d+w)≥ρg*[w′*l*t], where A represents an inherent adsorption force of the suction nozzle, d represents a coefficient determined by a distance between the suction nozzle and the alignment liquid, w represents a coefficient determined by a width of the opening of the suction nozzle, ρ represents a density of the alignment liquid, g represents a gravity constant, w′ represents the adsorption width of the suction nozzle, l represents a length of the opening of the suction nozzle, and t represents a thickness of the alignment liquid.

7. A device for applying an alignment liquid, comprising:
a delivery mechanism configured to deliver a substrate to a region where the alignment liquid is to be applied, the substrate comprising a display region and a non-display region surrounding the display region;
an application mechanism configured to apply the alignment liquid to the substrate at an alignment liquid application region covering an entirety of the display region and at least a part of the non-display region surrounding the display region;
a vacuum adsorption mechanism configured to absorb the alignment liquid on the substrate through vacuum adsorption; and
a control mechanism configured to control the vacuum adsorption mechanism, to remove, through the vacuum adsorption, at least a part of the alignment liquid at the non-display region.

8. The device according to claim 7, wherein
signal lines are arranged at the display region, external connection points for the signal lines are arranged at the non-display region, and the alignment liquid application region comprises a region where the external connection points are located; and
the control mechanism is further configured to control the vacuum adsorption mechanism, to merely remove the alignment liquid at the region where the external connection points are located.

9. The device according to claim 8, wherein
the vacuum adsorption mechanism comprises a suction nozzle; and
the control mechanism is further configured to control the suction nozzle of the vacuum adsorption mechanism, to remove, through the vacuum adsorption, the alignment liquid at the region where each of the external connection points is located in accordance with a direction in which the external connection points are arranged.

10. The device according to claim 9, wherein an adsorption width of the suction nozzle is equal to a sum of a width of each of the external connection points and a diffusion coefficient of the alignment liquid.

11. The device according to claim 10, wherein the diffusion coefficient of the alignment liquid is in a range from 0.8 mm to 3.2 mm.

12. The device according to claim 9, wherein
the suction nozzle is of a rectangular opening; and
an adsorption force Y of the suction nozzle is calculated using a formula: Y=A/(l+d+w)≥ρg*[w′*l*t], where A represents an inherent adsorption force of the suction nozzle, d represents a coefficient determined by a distance between the suction nozzle and the alignment liquid, w represents a coefficient determined by a width of the opening of the suction nozzle, ρ represents a density of the alignment liquid, g represents a gravity constant, w′ represents the adsorption width of the suction nozzle, l represents a length of the opening of the suction nozzle, and t represents a thickness of the alignment liquid.
